(19) United States
(12) Patent Application Publication
(10) Pub. No.: US 2008/0263587 A1
(43) Pub. Date: Oct. 23, 2008

(54) Dynamic Commercials

(76) Inventor: Tod Andrew DeBie, Costa Mesa, CA (US)

Correspondence Address: TOD DEBIE, 2190 PLACENTIA AVE., # C, COSTA MESA, CA, 92627, US

(21) Appl. No.: 11/738,519

(22) Filed: Apr. 23, 2007

(51) Int. Cl. H04N 7/00

(52) U.S. Cl. 725/34

(57) ABSTRACT

A method of selecting different viewers in the same broadcast market for different commercials to be displayed at the same time and on the same channel.

### BACKGROUND OF THE INVENTION

1. Field of Invention

This invention generally relates to television commercials, specifically to dynamically displaying different commercials to different viewers at the same time and conducting certain operations on said commercials.

2. Background of the Invention

Television broadcasters or service providers typically run commercials during television programs over cable, terrestrial broadcast, satellite broadcast and even pre-recorded programs.

Commercials run in a given market or region are typically the same. For example, all viewers in the same city or city block are likely to see the same set of commercials if they watch at the same time on the same channel and they are using the same television service provider (broadcast, cable, satellite, etc.).

Commercials can typically only be varied by broadcast region. Broadcast regions are defined by the television service providers and typically relate to geographic areas. For example, a given city, zip code or other boundary may define one broadcast region inside which all the content, programs and commercials, will be the same.

The commercials between two different regions may be the same or different. One commercial may run at the same time and on the same channel in every market across the USA, while the next commercial on the same channel might be different in every market and the commercial after that may be the same in some markets but different in others.

As a result of this, commercials can be targeted no more granularly than to the audience likely to be watching a given channel in a given region at a given time.

There remains a need in the art for systems and methods to display commercials in a region in a more efficient manner.

### SUMMARY

Accordingly, several advantages are provided, according to one or more embodiments, which may include displaying different commercials to different viewers at the same time on the same channel in the same broadcast region. For example, one viewer might see commercial A on channel 102 at 5:45 PM on Dec. 15, 2006 and their next door neighbor, who has the same television service provider and is in the same broadcast market, might see commercial B even though they are watching the same channel at the same time.

Another advantage allows users to review commercials after they have run and get more information on the subject of the commercial.

Another advantage allows the commercial to be displayed in a given timeslot no matter what channel is being watched.

Further advantages will become apparent from a consideration of the drawings and ensuing description.

### BRIEF DESCRIPTION OF DRAWINGS

Aspects of this disclosure are illustrated by way of example, and not by way of limitation, in the accompanying drawings, wherein:

FIG. 1 depicts how an embodiment of the invention displays different commercials to different viewers at the same time in the same broadcast region.

FIG. 2 depicts how another embodiment of the invention displays different commercials to different viewers at the same time in the same broadcast region.

FIG. 3 depicts how an embodiment of the invention stores and conducts certain operations on stored commercials.

### DETAILED DESCRIPTION

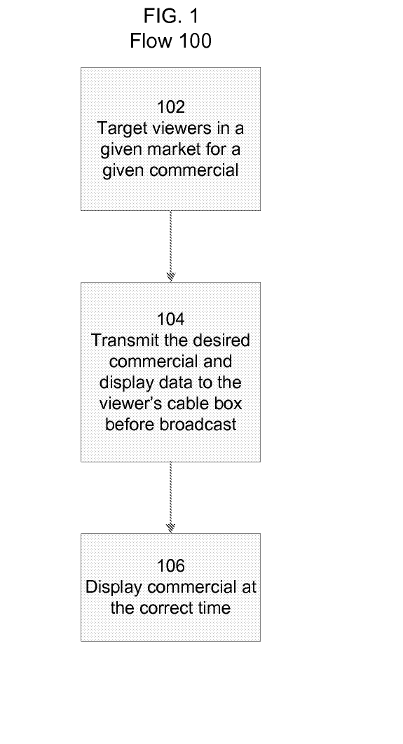

FIG. 1 depicts a flowchart of an exemplary method for displaying different commercials to different users at the same time in the same broadcast region. In reference to FIG. 1, an exemplary flow 100 may comprise one or more operations as follows:

In operation 102, viewers are selected in a given market for a given commercial. For example, Huntington Beach, Calif. might be a single broadcast market where existing systems and methods would not allow commercials to be targeted more granularly than at a given time and channel for the whole market. In operation 102, the viewers inside Huntington Beach, Calif. might be divided up where households of families with small children are in group 1, single males aged 18 to 45 are in group 2, households with teenage girls are in a group 3, and all other households are in a group 4.

Commercials may then be assigned to each group, where group 1 might be assigned a Disneyland commercial, group 2 might be assigned a Rocky XIV movie commercial, group 3 might be assigned a Revlon commercial and group 4 might be assigned a Ford commercial.

In operation 104, commercials are transmitted to viewers before the commercials are actually run. In one embodiment, the commercials will be transmitted to and cached in the viewer's cable boxes, digital video recorders, televisions, computers or other devices where said devices are enabled to cache the commercials.

Along with the commercial, additional data will be transmitted to describe when the commercial should be displayed, per the assignments from operation 102. For example, one commercial might be transmitted with data instructing that the commercial be displayed on channel 182 at 15:52:31 on Dec. 20, 2006. Another might be transmitted with data instructing that the commercial be displayed as the first commercial in the next commercial break on whatever channel is being viewed. Another might be transmitted with data instructing that the commercial be displayed as the first commercial in the next commercial break on a specific channel. Another might be transmitted with data instructing that the commercial be displayed on a periodic basis on a given or all channels in given time ranges or any time of the day. Another might be transmitted with data instructing that the commercial be displayed during shows of a specific type (news, drama, etc.). Another might be transmitted with data instructing that the commercial be displayed in specific geographic regions, such as all houses in a certain development or all houses on or near the beach.

In an alternate embodiment, the data about what commercial to display when may be included in the broadcast stream. Instead of the commercial itself, it may contain a reference saying play commercial 1 here. Or it may contain a reference that says play commercial 1 here for this viewer or group of viewers, put play commercial 2 for that viewer or group of viewers..

Dynamic commercials may be designated to play in a predetermined dynamic commercial timeslot or they may be designated to play instead of a commercial broadcast in the channel with a television program. In the former mode, broadcasters may have a gap in the television program commercial break where dynamic commercials are to be played. In the latter example, broadcasters will have commercials in the channel transmission with a television program, as with the background of this invention, and then, according to the transmitted instructions, play the dynamic commercial instead of the commercial broadcast in the channel with a television program.

In some embodiments, the commercials may be displayed during pre-recorded programs, such as DVDs. In these cases, the channel that the user is watching is the pre-recorded content. The pre-recorded program may display commercials before, during or after a movie or the primary content. The pre-recorded program might ship with static commercials but be enabled to allow dynamic commercials to be substituted or added to the existing commercials, or it may be enabled purely for dynamic commercials. The commercials might be advertisements or trailers for other movies, or for anything else.

In operation 106, the commercials are displayed according to the instruction data transmitted in operation 104.

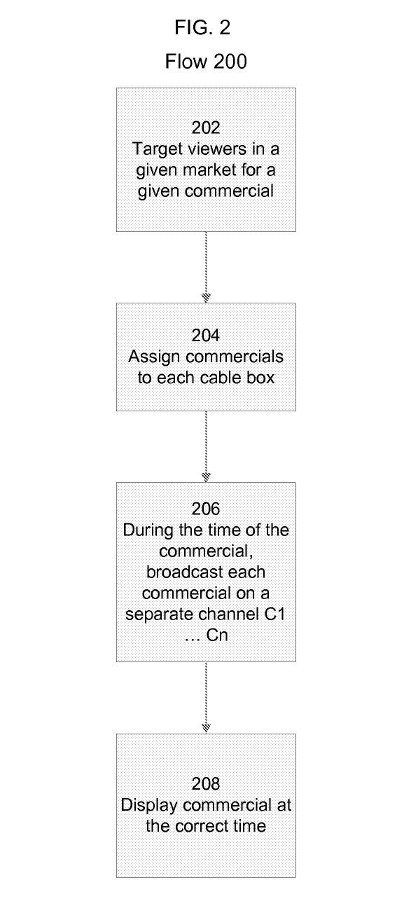

FIG. 2 depicts a flowchart of an exemplary method for displaying different commercials to different users at the same time in the same broadcast region. In reference to FIG. 2, an exemplary flow 200 may comprise one or more operations as follows:

In operation 202, viewers are selected in a given market for a given commercial. For example, Huntington Beach, Calif. might be a single broadcast market where existing systems and methods would not allow commercials to be targeted more granularly than at a given time and channel for the whole market. In operation 202, the viewers inside Huntington Beach, Calif. might be divided up where households of families with small children are in group 1, single males aged 18 to 45 are in group 2, households with teenage girls are in a group 3, and all other households are in a group 4.

Commercials may then be assigned to each group, where group 1 might be assigned a Disneyland commercial, group 2 might be assigned a Rocky XIV move commercial, group 3 might be assigned a Revlon commercial and group 4 might be assigned a Ford commercial.

In operation 204, data will be transmitted to the viewers to describe when the commercials assigned in operation 202 should be displayed. In one embodiment, the data will be transmitted to and cached in the viewer's cable boxes, digital video recorders, televisions, computers or other devices where said devices are enabled to cache the data and carry out its instructions.

In operation 206, in a given commercial timeslot, broadcasters will transmit or otherwise make available the dynamic commercials on alternate channels or other mediums where they can be downloaded and/or received and displayed to the user per the data transmitted in operation 204. In one embodiment, several transmission channels not normally viewable directly by viewers are setup to transmit the dynamic commercials. For example, dynamic commercial 1 might be broadcast on C1, dynamic commercial 2 might be broadcast on C2, and so on. Other embodiments may use other methods to deliver the commercials to the viewers, which may include internet transmission of the commercial.

In operation 208, the commercials are displayed to the users per the data transmitted in operation 204. In one embodiment, a user might be watching channel 102, and the dynamic commercial data from operation 204 might instruct the commercial on C4 at 5:45:30 PM on Dec. 20, 2006 to be displayed to the user. Other embodiments may use other methods to assign, deliver and display the commercials.

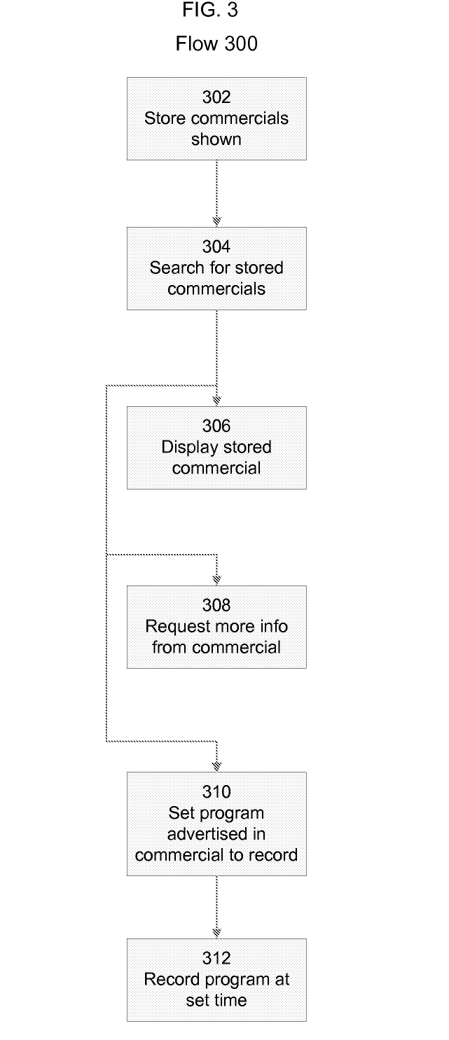

FIG. 3 depicts a flowchart of an exemplary method for storing commercials and conduction certain operations on them. In reference to FIG. 3, an exemplary flow 300 may comprise one or more operations as follows:

In operation 302, commercials that are displayed are also stored. This storage may occur on a digital video recorder, in a cable box or on some other type of storage device. In some embodiments, the storage may occur in a central location, such as on storage devices at the cable television provider. The storage may be very short term, lasting only minutes, or long term, lasting years.

In operation 304, the viewer can search for stored commercials. To bring up the search or results, the viewer may press one or more buttons on a remote control device. To conduct the search, the user may enter one or more search terms, dates or other information, or the search may display everything that is available. The search results will generally be viewed on a television or computer screen.

From the search results screen in operation 304, the viewer may display the commercial in operation 306 or request more information on the product in the commercial in step 308. The request for more information may take many forms. The request might display a web page for more information, cause more information to be mailed, electronically or physically, to the viewer or use other means to get more information to the viewer.

Certain commercials are advertising a particular television program or series that is playing at a particular time or at some point in the future, such as the next season. When a user views the search results from operation 304, and the commercial they are interested in is of this type, in operation 310 the user can set the program or series advertised in the commercial to record.

The recording itself happens in operation 312 and may take place on a digital video recorder, a video cassette recorder or some other type of recording or storage device. In some embodiments, the recording or storage may occur in a central location, such as on storage devices at the cable television provider. All of the embodiments for the recording of the advertised program share the common result of storing the advertised program when it is broadcast according to its schedule so that it may be viewed at some point after the original broadcast by the viewer by playing back the recorded program.

I claim:

1. A method of dynamically displaying a commercial, comprising:
selecting different viewers in the same broadcast market for different commercials to be displayed at the same time and on the same channel.

2. The method of claim 1, further comprising:
displaying the different commercials to the different viewers according to the assignments of claim 1.

3. The method of claim 1, further comprising:
transmitting the different commercials to the viewer before they are to be displayed.

4. The method of claim 1, further comprising:
transmitting information about when the different commercials are to be displayed to the viewer.

5. The method of claim 1, further comprising:
transmitting through alternate channels the different commercials at the time they are to be displayed.

6. The method of claim 5, further comprising:
displaying the commercials from the alternate channels to the viewer according to the assignments of claim 1.

7. A method of storing displayed commercials, comprising:
storing commercials displayed to the viewer on a storage device.

8. The method of claim 7, further comprising:
searching for stored commercials.

9. The method of claim 7, further comprising:
displaying stored commercials.

10. The method of claim 7, further comprising:
requesting information about the products featured in the stored commercials.

11. The method of claim 7, further comprising:
setting a program advertised in a stored commercial to record.

12. The method of claim 7, further comprising:
setting a series advertised in a stored commercial to record.

13. The method of claim 7, further comprising:
recording a program advertised in a stored commercial.

14. The method of claim 7, further comprising:
recording a series advertised in a stored commercial.

15. A method of dynamically displaying a commercial, comprising:
selecting different commercials to dynamically target.

16. The method of claim 15, further comprising:
displaying the targeted commercials at their designated time.
